(19) United States
(12) Patent Application Publication
(10) Pub. No.: US 2020/0144843 A1
(43) Pub. Date: May 7, 2020

(54) CHARGING SYSTEM

(71) Applicant: ABB Schweiz AG, Baden (CH)

(72) Inventor: Johan Kaptein, Den Haag (NL)

(21) Appl. No.: 16/736,366

(22) Filed: Jan. 7, 2020

Related U.S. Application Data
(63) Continuation of application No. PCT/EP2018/068635, filed on Jul. 10, 2018.

(30) Foreign Application Priority Data
Jul. 10, 2017 (EP) 17180602.9

(51) Int. Cl. H02J 7/00; B60L 53/62; B60L 53/16

(52) U.S. Cl. CPC H02J 7/00304; B60L 53/16; B60L 53/62

(57) ABSTRACT

The invention relates to a charging system configured for providing electrical energy to charge a battery of an electrical vehicle with a charging current I_{C}, including an overcurrent protection device wherein a breaking current Ib switching off the overcurrent protection device, an electrically controlled switch wherein switching a maximum switching current Iₘₐₓ, and a control device in electrical connection with at least the electrically controlled switch, whereby the electrically controlled switch and the overcurrent protection device are connected in series and arranged in the current path of the charging current I_{c}, and the control device is configured for switching off the electrically controlled switch at a time t>0 after the charging current I_{c} has exceeded the nominal current I_{N} or after the overcurrent protection device has switched off due to the charging current I_{c} has exceeded the breaking current I_{b}.

### TECHNICAL FIELD

The invention relates to a charging system configured for providing electrical energy to charge a battery of an electrical vehicle with a charging current I_{c}, comprising an overcurrent protection device characterized by a breaking current I_{b} switching off the overcurrent protection device.

### BACKGROUND ART

Charging systems for providing electrical energy to charge a battery of an electrical vehicle are known from prior art. Said charging systems are usually connected on an AC side with a power source such as an AC grid and comprise on a DC side a plurality of charging ports providing charging current. Each charging port comprises an interface for energy exchange between the charging system and the electrical vehicle via a cable. The cable as well as other cables provided in the charging system are normally protected by fuses on the battery side and a limited current on the charger side, provided for example as fuses on the DC side and/or as fuses on the AC side of the charging system. If a short circuit occurs when charging the electrical vehicle the fuse in the electrical vehicle will break if the short circuit current is large enough. As the fuse in the electrical vehicle is hard to reach replacing a broken fuse is laborious and costly.

In practise, the let through energy of the fuse is often chosen very high, for example 12 MA²s, compared to the expected charging current required for charging the electrical vehicle. When an overcurrent occurs for example by a weak short circuit or a malfunction of the charger system, the overcurrent can be detected and the charging should be interrupted by an electrically controlled switch arranged in the charging path of the charging current. Electrically controlled switches, however, have a limited breaking capacity. If the breaking capacity is exceeded the electrically controlled switch can be destroyed. Replacing a destroyed electrically controlled switch is much more costly than replacing a broken fuse.

### SUMMARY OF INVENTION

It is therefore an object of the invention to provide a system and a method for protecting an electrically controlled switch of a charging system for providing electrical energy to charge a battery of an electrical vehicle.

The object of the invention is solved by the features of the independent claims. Preferred embodiments are described in the dependent claims.

Thus, the object is solved by a charging system configured for providing electrical energy to charge a battery of an electrical vehicle with a charging current I_{c}, whereby the charging system is characterized by a nominal current I_{N}, comprising an overcurrent protection device characterized by a breaking current I_{b} switching off the overcurrent protection device, whereby I_{b}≥I_{N}, an electrically controlled switch characterized by switching a maximum switching current Iₘₐₓ, and a control device in electrical connection with at least the electrically controlled switch, whereby the electrically controlled switch and the overcurrent protection device are connected in series and arranged in the current path of the charging current I_{c}, and the control device is configured for switching off the electrically controlled switch at a time t>0 after the charging current I_{c} has exceeded the nominal current I_{N} or after the overcurrent protection device has switched off due to the charging current I_{c} has exceeded the breaking current I_{b}.

A key point of the invention is therefore to let the overcurrent protection device switch off an overcurrent resulting for example from a malfunction if the overcurrent is larger than the nominal current I_{N}, and thereafter, once the overcurrent protection device has switched off, first to wait the time t>0 and then second to switch off the electrically controlled switch. If the overcurrent protection device has not switched off within the time t=I²t/I_{b}², a fault current is below Iₘₐₓ and the electrically controlled switch can break the charging current I_{c}. Therefore, the breaking capacity of the overcurrent protection device is chosen higher than of the electrically controlled switch. In such was it is ensured that the breaking capacity of the electrically controlled switch is never exceeded i.e. that the electrically controlled switch cannot be destroyed by an overcurrent. In other words, to prevent fusing the electrically controlled switch the idea is to wait for the overcurrent protection device to blow before opening the electrically controlled switch, at the time t after the overcurrent protection device has blown. In this way the electrically controlled switch is prevented against damage occurred by an overcurrent. The term overcurrent may relate to an overcurrent, a short circuit, a fault and/or a malfunction of the charging system and thereto connected devices such as the electrical vehicle, a cable connecting the charging system and the electrical car, a power grid or the like.

An electrical vehicle, abbreviated as EV and as also referred to as an electric drive vehicle or electric vehicle, uses one or more electric motors or traction motors for propulsion. EVs may include road and rail vehicles, surface and underwater vessels, electric aircraft and electric spacecraft. The term opening or switching off respectively closing or switching on means that an electrical connection is interrupted respectively established, for example by the overcurrent protection device or the electrically controlled switch. The term maximum switching current Iₘₐₓ is to be understood as the maximum current that can be switched by the electrically controlled switch with destroying or damaging the electrically controlled switch, for example as the designed load current per contact of the electrically controlled switch. The breaking current I_{b} is to be understood as the current which causes the overcurrent protection device to switch off. The battery is preferably provided as a DC battery.

According to a preferred embodiment, the control device is configured for measuring the charging current I_{c} and for switching off the electrically controlled switch if the charging current I_{c} has exceeded the nominal current I_{N} or the breaking current I_{b}. Preferably the control device comprises an ammeter arranged in the current path for measuring the charging current I_{c}. It can be possible to measure the charging current I_{c} within the electrical vehicle for example directly at the battery of the electrical vehicle, at the cable connecting the electrical vehicle with a charging device provided within the charging system. Switching off the electrically controlled switch can be done, for example, by sending a switching signal from the control device to the electrically controlled switch.

According to another preferred embodiment, the overcurrent protection device is characterized by a let through energy I²t and the time t is the let through energy I²t divided by the square of the breaking current I_{b}, t=I²t/I_{b}². Thus, for example, if I²t equals 120 kA²s and the breaking current I_{b} equals 200 A then the time t is 3 seconds. The let through energy I²t, ampere squared seconds, is to be generally understood as an expression related to a circuit energy as a result of a current. With respect to an overcurrent protection device respectively a circuit breaker, the let through energy I²t is preferably expressed for the current flow between an initiation of a fault current and clearing of the overcurrent protection device respectively the circuit breaker. Waiting said time t=I²t/I_{b}² has been proven as very advantageous for protecting the electrically controlled switch against damage due to an overcurrent.

According to another preferred embodiment, the charging system comprises the electrical vehicle and a charging device configured for charging the electrical vehicle, whereby the electrical vehicle and/or the charging device comprises the overcurrent protection device and the charging device comprises the electrically controlled switch and the control device. The charging device is preferably provided as a DC charger with, for example, 50 kW DC fast charging capability thus allowing a typical charging of 30 to 80% in 15 minutes at an output voltage of 200-500 V at 125 A (Combo-1) or 50-500 V at 120 A (CHAdeMO) and/or may fulfil EN61851-23/DIN 70121 Combo-1 and/or CHAdeMO 1.0 DC connection standards for a charging port.

According to another preferred embodiment, the electrically controlled switch and the overcurrent protection device are connected in series between the electrical vehicle and the charging device. Preferably, the electrically controlled switch and the overcurrent protection device are provided within an enclosure of the charging device.

According to another preferred embodiment, the charging system comprises a cable configured for electrically connecting the electrical vehicle and the charging device for conducting the charging current I_{c}. The cable my comprise connectors for connecting to the electrical vehicle and an interface of a charging port of the charging device.

According to another preferred embodiment, the electrically controlled which is provided as a contactor. A contactor is an electrically controlled switch for switching an electrical power circuit and is often controlled by a circuit which has a lower power level than the switched circuit.

According to another preferred embodiment, the overcurrent protection device is provided as a fuse or as a circuit breaker and/or the overcurrent protection device is characterized by a current time graph, whereby the time t corresponds to the breaking current I_{b}. A circuit breaker is an automatically operated electrical switch designed to protect the electrical circuit formed by the charging system from damage caused by overcurrent or overload or short circuit. Once the charging current I_{c} has exceeded the nominal current I_{N} or the breaking current I_{b}, the circuit breaker interrupts respectively switches off the current path of the charging current after protective relays of the circuit breaker have detected the fault. The fuse works in an analogue manner, but comprises a metal wire or strip that melts when to much current flows through it thereby interrupting the current path of the charging current L.

According to another preferred embodiment, the charging system comprises a plurality of power converters configured for converting electrical energy from a power source such as a power grid to a suitable format for charging the electrical vehicle. According to another preferred embodiment, the plurality of power converters each have an AC side configured for connecting to the power source and an DC side configured for providing electrical energy to the battery of the electrical vehicle, whereby the overcurrent protection device is arranged on the AC side and/or on the DC side of the plurality of power converters. The power converter is preferably configured for converting AC power from the power source connected to the AC side to suitable DC format for charging the electrical vehicle at the DC side.

According to another preferred embodiment, the overcurrent protection device, the electrically controlled switch and/or the control device comprise a communication device configured for exchanging information regarding breaking current I_{b}, maximum switching current Iₘₐₓ, let through energy I²t, charging current I_{c} and/or time t with at least the electrical vehicle. Preferably, such control device is installed at each of the overcurrent protection device, the electrically controlled switch, the control device and the electrical vehicle, thereby allowing an easy exchange of said information.

According to another preferred embodiment, the charging system comprises a plurality of charging ports each comprising an interface for energy exchange with at least one electrical vehicle. The charging port, also referred to as an outlet, may comprise a JARI Level 3 DC connector as interface. According to a further preferred embodiment, the maximum switching current Iₘₐₓ is greater than the breaking current I_{b}.

The object of the invention is further solved by a method for protecting an electrically controlled switch when charging a battery of an electrical vehicle with a charging current I_{c}, whereby the charging system is characterized by a nominal current I_{N}, comprising an overcurrent protection device characterized by a breaking current I_{b} switching off the overcurrent protection device, whereby I_{b}≥I_{N}, and the electrically controlled switch characterized by switching a maximum switching current Iₘₐₓ, whereby the electrically controlled switch and the overcurrent protection device are connected in series and arranged in the current path of the charging current I_{c}, comprising the steps of:

detecting, if the charging current I_{c} has exceeded the nominal current I_{N} or if the overcurrent protection device and has switched off due to the charging current I_{c} has exceeded the breaking current I_{b}, and in such case switching off the electrically controlled switch at a time t>0 after the charging current I_{c} has exceeded the nominal current I_{N} or after the overcurrent protection device has switched off.

A key point of the method is therefore to protect the electrically controlled switch from damage or destruction to an overcurrent by waiting for the overcurrent protection device to switch off as a result of the overcurrent and thereafter to open the electrically controlled switch, at the time t after the overcurrent protection device has switched-off. The overcurrent occurs if the charging current I_{c} exceeds the nominal current I_{N} thereby causing the overcurrent protection device to switch off.

According to a further preferred embodiment, the overcurrent protection device is characterized by a let through energy I²t and the time t is the let through energy I²t divided by the square of the breaking current I_{b}, t=I²t/I_{b}².

Further embodiments and advantages of the method are directly and unambiguously derived by the person skilled in the art from the system as described above.

### BRIEF DESCRIPTION OF DRAWINGS

These and other aspects of the invention will be apparent from and elucidated with reference to the embodiments described hereinafter.

In the drawings:

FIG. 1 shows a charging system according to preferred embodiment of the invention in a schematic view.

### DESCRIPTION OF EMBODIMENTS

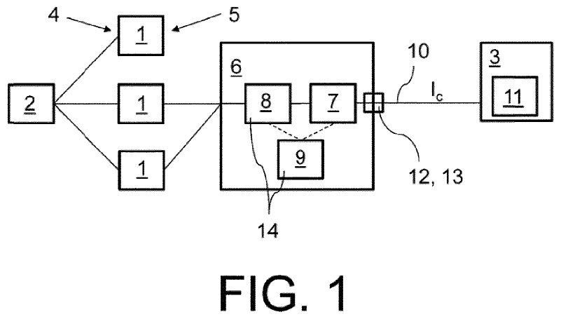

FIG. 1 shows a charging system according to preferred embodiment of the invention in a schematic view comprising a plurality of power converters 1 i.e. three power converters 1, which are each configured for converting electrical energy from a power source 2, such as a power grid, to a suitable format for charging an electrical vehicle 3.

Each power converter 1 comprises an AC side 4, which is connected to the power source 2, and an DC side 5, which is connected to a charging device 6. While FIG. 1 shows only one charging device 6, multiple charging devices 6 can be present and connected to one or more of the power converters 1. As shown in the FIGURE, the charging device 6 is electrically connected to two power converters 1. The term connected is to be understood as electrically connected.

The charging device 6 comprises an overcurrent protection device 7, an electrically controlled switch 8 and a control device 9. The overcurrent protection device 7 and the electrically controlled switch 8 are arranged in series between the power converters 1 connected to the charging device 6 and a DC cable 10, which connects a DC battery 11 of the electrical vehicle 3 with the charging device 6 for conducting a charging current I_{c}. In this way the overcurrent protection device 7 and the electrically controlled switch 8 are arranged in the current path of the charging current I_{c}. A likely source of an overcurrent is a battery of the electrical vehicle 3.

The charging device 6 further comprises a plurality of charging ports 12 for connecting the DC cable 10, whereby each charging port 11 comprises an interface 13 such as a jack. A current rating of the charging device 6 is less or equal to a current rating of charging ports 12 respectively interface 13. In an alternate not shown embodiment the overcurrent protection device 7 can be arranged on the AC side 4 or a plurality of overcurrent protection devices 7 can be arranged both on the AC side 4 and on the DC side 5.

The overcurrent protection device 7 is provided as a fuse or as a circuit breaker and is characterized by a breaking current I_{b} and by a let through energy I²t. If the charging current I_{c} exceeds the breaking current I_{b} the overcurrent protection device 7 switches off i.e. “blows” and thus interrupts the charging of the electrical vehicle 3. The electrically controlled switch 8 is provided as a contactor and is characterized by a maximum switching current Iₘₐₓ, which is greater than the breaking current I_{b}.

The control device 9 is in electrical connection with the overcurrent protection device 7 and the electrically controlled switch 8. In this way the overcurrent protection device 7, the electrically controlled switch 8, the electrical vehicle 3 and the control device 9 each comprise a communication device 14, which is configured for exchanging information regarding the breaking current I_{b}, the maximum switching current Iₘₐₓ, the let through energy I²t, the charging current I_{c} and a time t explained below.

If the charging current I_{c} exceeds the breaking current I_{b}, first the overcurrent protection device 7 switches off. The control device 9 is configured for switching off the electrically controlled switch 8 at the time t>0 after the overcurrent protection device 7 has switched off or after the charging current I_{c} has exceeded a nominal current I_{N} of the charging system respectively charging device 6. Therefore, the control device 9 is configured to measure the charging current I_{c}. The time t is calculated by the control device 9 as the let through energy I²t of the overcurrent protection device 7 divided by the square of the breaking current I_{b} i.e. as t=I²t/I_{b}².

Thus, in order to prevent fusing of the electrically controlled switch 8 due to an overcurrent or a malfunction the control device 9 first “waits” until the overcurrent protection device 7 switches off and second, at the timespan t thereafter, opens respectively switches off the electrically controlled switch 8. For example, with I²t=120 kA²s and I_{b}=200 A, the time t is 3 seconds. Thus, with the present example, if an overcurrent has occurred e.g. if the charging current I_{c} has exceeded the breaking current I_{b}, the overcurrent protection device 7 switches off and thereby interrupts the charging of the electrical vehicle. 3 second thereafter, the control device 9 causes the electrically controlled switch 8 to switch off. Thereby, the electrically controlled switch 8 is protected from breaking due to the overcurrent.

While the invention has been illustrated and described in detail in the drawings and foregoing description, such illustration and description are to be considered illustrative or exemplary and not restrictive; the invention is not limited to the disclosed embodiments. Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

1 power converter
2 power source
3 electrical vehicle
4 AC side
5 DC side
6 charging device
7 overcurrent protection device
8 electrically controlled switch
9 control device
10 cable
11 battery
12 charging port
13 interface
14 communication device

1. A charging system configured for providing electrical energy to charge a battery of an electrical vehicle with a charging current I_{c}, the charging system is characterized by a nominal current I_{N}, comprising
an overcurrent protection device (7) characterized by a breaking current I_{b} switching off the overcurrent protection device, wherein I_{b}≥I_{N},
an electrically controlled switch (8) characterized by switching a maximum switching current Iₘₐₓ, and
a control device in electrical connection with at least the electrically controlled switch, wherein
the electrically controlled switch and the overcurrent protection device are connected in series and arranged in the current path of the charging current I_{c}, and
the control device is configured for switching off the electrically controlled switch at a time t>0 after the charging current I_{c} has exceeded the nominal current I_{N} or after the overcurrent protection device has switched off due to the charging current I_{c} has exceeded the breaking current I_{b}.

2. The charging system according to claim 1, wherein the control device is configured for measuring the charging current I_{c} and for switching off the electrically controlled switch if the charging current I_{c} has exceeded the nominal current I_{N} or the breaking current I_{b}.

3. The charging system according to claim 1, wherein the overcurrent protection device a let through energy I²t and the time t is the let through energy I²t divided by the square of the breaking current I_{b}, t+I²t/I_{b}².

4. The charging system according to claim 1, comprising the electrical vehicle and a charging device configured for charging the electrical vehicle, wherein the electrical vehicle and/or charging device comprises the overcurrent protection device and the charging device comprises the electrically controlled switch and the control device.

5. The charging system according to claim 1, wherein the electrically controlled switch and the overcurrent protection device are connected in series between the electrical vehicle and the charging device.

6. The charging system according to claim 1, further comprising a cable configured for electrically connecting the electrical vehicle and the charging device for conducting the charging current I_{c}.

7. The charging system according to claim 1, wherein the electrically controlled switch is provided as a contactor.

8. The charging system according to claim 1, wherein the overcurrent protection device is provided as a fuse or as a circuit breaker, and/or the overcurrent protection device (7) is characterized by a current time graph, wherein the time t corresponds to the breaking current I_{b}.

9. The charging system according to claim 1, further comprising a plurality of power converters configured for converting electrical energy from a power source such as a power grid to a suitable format for charging the electrical vehicle.

10. The charging system according to claim 1, wherein the plurality of power converters each have an AC side configured for connecting to the power source and an DC side configured for providing electrical energy to the battery of the electrical vehicle, wherein the overcurrent protection device is arranged on the AC side and/or on the DC side of the plurality of power converters.

11. The charging system according to claim 1, wherein the overcurrent protection device, the electrically controlled switch and/or the control device comprise a communication device configured for exchanging information regarding breaking current I_{b}, maximum switching current Iₘₐₓ, let through energy I²t, charging current I_{c} and/or time t with at least the electrical vehicle.

12. The charging system according to claim 1, further comprising a plurality of charging ports each comprising an interface for energy exchange with at least one electrical vehicle.

13. The charging system according to claim 1, wherein the maximum switching current Iₘₐₓ is greater than the breaking current I_{b}.

14. A method for protecting an electrically controlled switch when charging a battery of an electrical vehicle with a charging current I_{c}, the charging system is characterized by a nominal current I_{c}, comprising
an overcurrent protection device (7) characterized by a breaking current I_{b} switching off the overcurrent protection device, wherein I_{b}≥I_{N}, and
the electrically controlled switch (8) characterized by switching a maximum switching current Iₘₐₓ, wherein
the electrically controlled switch and the overcurrent protection device are connected in series and arranged in the current path of the charging current I_{c}, the method comprising the steps of:
detecting, if the charging current I_{c} has exceeded the nominal current I_{N} or if the overcurrent protection device and has switched off due to the charging current I_{c} has exceeded the breaking current I_{b}, and
in such case switching off the electrically controlled switch at a time t>0 after the charging current I_{c} has exceeded the nominal current I_{N} or after the overcurrent protection device has switched off.

15. The method according to claim 14, wherein the overcurrent protection device is characterized by a let through energy I²t and the time t is the let through energy I²t divided by the square of the breaking current I_{b}, t=I²t/I_{b}².

16. The charging system according to claim 2, wherein the overcurrent protection device is characterized by a let through energy I²t and the time t is the let through energy I²t divided by the square of the breaking current I_{b}, t I²t/I_{b}².

17. The charging system according to claim 16, comprising the electrical vehicle and a charging device configured for charging the electrical vehicle, wherein the electrical vehicle and/or charging device comprises the overcurrent protection device and the charging device comprises the electrically controlled switch and the control device.

18. The charging system according to claim 17, wherein the electrically controlled switch and the overcurrent protection device are connected in series between the electrical vehicle and the charging device.

19. The charging system according to claim 18, further comprising a cable configured for electrically connecting the electrical vehicle and the charging device for conducting the charging current I_{c}.

20. The charging system according to claim 19, wherein the overcurrent protection device is provided as a fuse or as a circuit breaker, and/or the overcurrent protection device is characterized by a current time graph, wherein the time t corresponds to the breaking current I_{b}.
